(19) United States
(12) Patent Application Publication
(10) Pub. No.: US 2017/0145730 A1
(43) Pub. Date: May 25, 2017

(54) SAFETY ACCESS TO A ROOM

(71) Applicant: Horst E. Dreier, Horb-Bittelbronn (DE)

(72) Inventor: Horst E. Dreier, Horb-Bittelbronn (DE)

(21) Appl. No.: 14/947,387

(22) Filed: Nov. 20, 2015

(51) Int. Cl. E05G 5/02; E04H 1/12; E05B 65/00

(52) U.S. Cl. CPC E05G 5/02; E05B 65/0075; E04H 1/125; E05Y 2900/132

(57) ABSTRACT

A safety access to a room in particular a class room with a safety lock, an entry from outside and an exit to the room, comprising a first door in the exit and a locking door which renders the locking chamber lockable.

### FIELD OF THE INVENTION

The invention relates to a safety access to a room, in particular a class room, The safety access shall protect people in the room, for example teachers and students from a homicidal attacker.

### BACKGROUND OF THE INVENTION

Safety accesses that allow only authorized persons to enter are known in the art.

### BRIEF SUMMARY OF THE INVENTION

The object is achieved by a safety access to a room in particular a class room with a safety lock, an entry from outside and an exit to the room, comprising a first door in the exit and a locking door which renders the locking chamber lockable.

The safety access includes a safety lock with a locking chamber and an entrance from an outside and an exit towards the room. The safety lock is a hallway, an ante chamber or similar which can also be arranged in the room and which can only be entered through the entrance and can only be exited through the exit. A person who wants to enter the room from outside has to move through the safety lock. The safety lock is advantageously closed above so that nobody can climb over it. The designations entry and exit have been selected for unambiguous identification, both are openings of the safety lock through which the safety lock can be entered and exited. Through the entrance the safety lock can be entered from outside and can be exited towards the outside and through the exit the safety lock can be exited towards the room and entered from the room. “Outside” is to be viewed relative to the room, it relates for example to a hallway in a building for reaching the room.

The locking chamber can be a portion of the safety lock or a room adjacent to the safety lock wherein the room is accessible from the safety lock and is advantageously not discernible as a proprietary separable room. The locking chamber is configured for locking up an unauthorized person, in particular a homicidal attacker which wants to penetrate the room.

The safety lock includes a first door in an exit from the safety lock towards the room by which the exit and thus the access to the room is closable. Furthermore the safety lock includes a locking door by which the locking chamber is lockable. An unauthorized person can be locked in the locking chamber by closing the locking door.

Advantageously the locking chamber is arranged opposite to the entrance, so that a nervous person with therefore reduced attention for his or her environment and who runs through the entrance into the safety lock with the intention to enter the room accidentally runs into the locking chamber of the safety lock where the person is lockable by closing the locking door. The exit from the safety lock into the room is advantageously arranged laterally relative to the entrance and to the locking chamber so that a nervous and inattentive person does not unintentionally enter the room from the safety lock through the exit.

The locking chamber and the room can respectively have proprietary doors. One configuration provides a common door which forms the first door in the exit from the safety lock to the room, as well as the locking door by which the locking chamber is lockable. Opening the first door which simultaneously forms the locking door simultaneously facilitates locking the locking chamber so that a person is lockable in the locking chamber and the room can be exited.

Advantageously the locking chamber is transparent towards the room so that an impression is conveyed to a nervous and inattentive person, in particular a homicidal attacker that he or she can enter the room through the locking chamber. Thus, the locking chamber does not have to be transparent in its entirety. A transparent portion suffices which conveys the impression of a pass through. In particular the locking chamber includes a glass pane or a transparent plastic pane through which the room with the people in the room is visible from the locking chamber and at least upon first glance the impression of an access to the room is conveyed. Advantageously the glass or transparent plastic pane is bullet resistant.

An alternative to transparency is a dummy door in the locking chamber which cannot be opened or cannot be opened from the locking chamber and behind which a homicidal attacker anticipates the room into which he wishes to enter.

Advantageously the first door in the exit from the safety lock to the room cannot be opened by hand from the safety lock. From the safety lock the first door can for example only be opened with a key. Otherwise the first door can be opened from the room by hand or with a key or via remote control from the room or from another location outside of the safety lock. An unauthorized person without a key does not get into the room through the safety lock when the first door is closed.

An embodiment of the invention provides a quick drive for the locking door for locking the locking chamber, The quick drive is a drive which closes the locking door quickly enough so that escaping the locking chamber during locking the locking door is impossible. The quick drive can operate mechanically for example with one or plural springs. It can operate electro mechanically with an electro magnet or an electric motor, pneumatically or hydraulically. The enumeration is exemplary but not final.

Advantageously the locking door locks the locking chamber self-acting when a person enters the locking chamber, This is for example provided with a light barrier, a motion detector or by depressing a door handle of a dummy door which cannot be opened by depressing the door handle. Triggering the locking door by a person which is in particular in the room is also possible.

An embodiment of the invention provides a constriction device for fixating a person in the locked locking chamber. The fixation does not have to be complete, however it restricts the movement of the person to use a weapon or to exercise force to relieve himself or herself from the locking chamber significantly. The restraining device can include a moving wall or another device which moves into the locking chamber and presses a person in the locking chamber against an opposite wall.

A configuration of the invention provides one or plural bags that are inflatable by a pressure medium like an air bag as a constriction device which can be inflated or filled in order to constrict the locking chamber and to fixate a person in the locking chamber, Differently from an air bag the bag or the bags of the restraining device according to the invention retain their interior pressure until the interior pressure is released. The pressure medium can be a liquid or a gas, a pyrotechnic unfolding of the bag or bags is also possible.

### BRIEF DESCRIPTION OF THE DRAWINGS

The invention is subsequently described in more detail based on an embodiment described in more detail with reference to drawing figures, wherein:

FIG. 1 illustrates a class room with a safety access according to the invention; and

FIG. 2 illustrates the safety access according to the invention with a locked locking chamber.

### DETAILED DESCRIPTION OF THE INVENTION

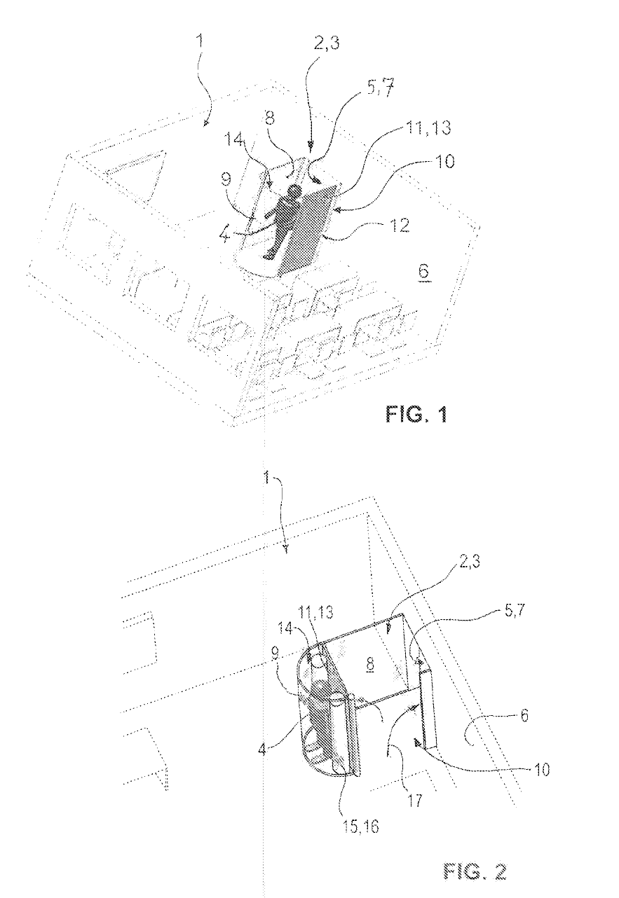

The class room 1 illustrated in FIG. 1 which generally represents a chamber or a room in a building includes a safety access 2 according to the invention with a safety lock 3 which protects students and teachers in the class room or generally people in the room against a homicidal attacker 4. The safety lock 3 is a short hall way or a small ante chamber in the class room 1 through which the class room 1 is entered or exited. The safety lock 3 connects to a wail opening 5 like a door opening in a wall 6 of the class room 1. The wall opening 5 is also designated as an entrance 7 of the safety lock 3 through which the safety lock 3 can be entered from an outside and exited towards the outside, Viewed from above the safety lock 3 in the embodiment is U-shaped with a flat side wall 8 and a semi cylindrical face wall 9 which is arranged opposite to the entrance 7. The side wall 8 and the face wall 9 in the embodiment are made from bullet resistant glass or bullet resistant plastic material so that a homicidal attacker which runs quickly and nervously and therefore with low attention for his environment through the entrance 7 into the safety lock has the impression that he can walk straight into the class room 1 since he sees people in the room through the transparent wall 8 and the face wall 9 of the safety lock 3.

The safety lock includes an opening opposite to the flat wall 8 wherein the opening is designated as an exit 10 and through which the class room 1 is entered from the safety lock 3 or vice versa. The class room 1 is exited through the safety lock 3. In the exit 10 the safety lock 3 includes a first door 11 which is closed in FIG. 1, this means it closes the exit 10. The first door 11 can be opened by hand by depressing a door handle 12 only from the class room 1, however not from the safety lock 3. The first door 11 can be opened from the safety lock 3 with a key or for example by typing in a code. Also a remotely controlled opening of the first door 11 can be possible, however, as stated supra there is no option to open the first door 11 by hand from the safety lock 3. To a person like the homicidal attacker 4 who runs into the safety lock 3 quickly and with a low level of attention for his environment the first closed door 11 on its one side looks like an open door of the entrance 7 through which the safety lock 3 can be entered from an outside. The safety lock 3 is closed on all sides and covered on top so that there is no option to enter the class room 1 when the first door 11 is closed like illustrated in FIG. 1, this means it closes the exit 10 of the safety lock 3 which leads into the class room 1. Therefore the homicidal attacker 4 runs through the entrance 7 straight into and through the safety lock 3 until he hits the transparent face wail 9 that is semi cylindrical in the embodiment which would typically subdue him already. As soon as the homicidal attacker 4 or another unauthorized person is in the semi cylindrical face wail 9 of the safety lock 3 the first door 11 which is simultaneously a locking door 13 is opened, wherein the first door 11 is pivoted into the safety lock 3. The first door 11 is pivoted by 90° into the safety lock 3 so that it locks the attacker 4 in the semi cylindrical face wall 9 of the safety lock 3 whose interior forms a locking chamber 14. In this locking position in which the first door 11 locks the homicidal attacker 4 in the locking chamber 14 the first door 11 which simultaneously forms the locking door 13 cannot be opened from the locking chamber 14. The homicidal attacker is caught in the locking chamber 14 until security opens the locking door 13 and arrests the attacker.

Opening the first door 11 which simultaneously forms the locking door 13 and pivoting it by 90° into the locking position in which the first door and thus the locking door 13 locks the locking chamber 14 is performed self-acting with a non illustrated quick drive which includes for example a spring for example a spiral spring or pneumatically. The quick drive can be triggered by remote control from the class room 1 and/or automatically for example by a light switch or a motion detector which determines when the locking chamber 9 is entered by the attacker 4.

In the entrance 7 a conventional room door can be provided which opens in outward direction or away from the first door 11 In the embodiment no door is provided in the entrance 7. The safety lock 3 can have another shape than the drawn shape and the described shape and transparent bullet resistant walls 8 and 9 are not mandatory but are advantageous.

Two gas tight bags 15 are arranged at inner corners between the locking door 13 and the semi cylindrical face wall 9 wherein the bags are inflatable like air bags with compressed gas or pyrotechnically, however, differently from an air bag they maintain an interior pressure until the interior pressure is released, In the embodiment the bags 15 inflate into cylinders as illustrated in FIG. 2 which illustrates the inflated bags 15. The bags 15 form a constriction device 16 which fixates the homicidal attacker 4 in the locking chamber 14 or at least significantly reduce his mobility.

Since the first door 11 which simultaneously forms the locking door 13 is opened when locking the locking chamber 14, this means the first door 11 opens the exit 10, an escape path 17 opens when the locking chamber 14 is locked wherein the escape path leads from the class room 1 through the exit 10 and the safety lock 3 in outward direction.

What is claimed is:

1. A safety access to a room, the safety access comprising:
a safety lock, including a locking chamber, an entrance from an outside, and an exit to the room;
a first door in the exit; and
a locking door which renders the locking chamber lockable.

2. The safety access according to claim 1, wherein the locking chamber is arranged opposite to the entrance and the exit is at one side of the safety lock with respect to the locking chamber and the entrance.

3. The safety access according to claim 1, wherein the first door forms the locking door.

4. The safety access according to claim 1, wherein the locking chamber is transparent towards the room.

5. The safety access according to claim 1, wherein the locking chamber includes a dummy door which is not openable or at least not openable from the locking chamber.

6. The safety access according to claim 1, wherein the first door is not openable by hand from the safety lock.

7. The safety access according to claim 1, wherein the locking door includes a quick drive for locking the locking chamber.

8. The safety access according to claim 1, wherein the locking door locks the locking chamber self-acting when a person enters the locking chamber.

9. The safety access according to claim 1, wherein the locking chamber includes a restraining device for fixating a person in the locked locking chamber.

10. The safety access according to claim 1, wherein the room is a class room.
